(19) United States
(12) Patent Application Publication
(10) Pub. No.: US 2022/0140665 A1
(43) Pub. Date: May 5, 2022

(54) Power Generator Separating Multiple Electric Sources

(71) Applicant: Fu-Hung Ho, Taichung City (TW)

(72) Inventor: Fu-Hung Ho, Taichung City (TW)

(21) Appl. No.: 17/086,587

(22) Filed: Nov. 2, 2020

(51) Int. Cl. H02K 1/16; H02K 3/28; H02K 7/18

(52) U.S. Cl. CPC H02K 1/16; H02P 25/22; H02K 7/183; H02K 3/28

(57) ABSTRACT

A power generator includes a stator iron core and a rotor iron core rotatably mounted in the stator iron core. The stator iron core is at least provided with a first alternating-current (AC) supply unit and a second alternating-current (AC) supply unit separated from each other. The first AC supply unit includes a plurality of first coil windings connected with a first anode electric wire and a first cathode electric wire. The second AC supply unit includes a plurality of second coil windings connected with a second anode electric wire and a second cathode electric wire. The first coil windings to have a winding direction opposite to that of the second coil windings so that the first coil windings and the second coil windings do not interfere with each other.

### BACKGROUND OF THE INVENTION

### 1. Field of the Invention

The present invention relates to an electric apparatus and, more particularly, to a power generator for generating electricity.

### 2. Description of the Related Art

An AC generator usually includes a single-phase generator, a two-phase generator, a three-phase, and a polyphase generator according to the phases outputted by the stator windings. A single-phase AC generator includes two wires. The popular AC generator is a three-phase 220V generator containing four wires. In general, the traditional AC generator is only used to output a single electric source.

A conventional single-phase two-wire generator 40 in accordance with the prior art shown in FIG. 1 comprises a stator iron core 41 and a rotor iron core 42 rotatably mounted in the stator iron core 41. An air gap 43 is defined between the stator iron core 41 and the rotor iron core 42 to allow rotation of the rotor iron core 42 in the stator iron core 41. The rotor iron core 42 is provided with a plurality of magnetic pole windings 46. The stator iron core 41 is provided with a plurality of stator grooved teeth 44. The stator iron core 41 is provided with a plurality of coil windings 45 wound around the stator grooved teeth 44. The coil windings 45 have a first terminal connected with a positive pole electric wire R1 and a second terminal connected with a negative pole electric wire R2. The positive pole electric wire R1 and the negative pole electric wire R2 are connected to a connecting terminal which is connected to a circuit which is connected to a load 47 to provide an AC voltage to the load 47. However, the conventional single-phase two-wire generator 40 needs an AC to DC converter and a DC to AC converter so as to provide the AC voltage to the load 47, thereby easily causing a loss due to transformation.

### BRIEF SUMMARY OF THE INVENTION

The primary objective of the present invention is to provide a power generator separating multiple electric sources.

In accordance with the present invention, there is provided a power generator comprising a stator iron core and a rotor iron core rotatably mounted in the stator iron core. An air gap is defined between the stator iron core and the rotor iron core to allow rotation of the rotor iron core in the stator iron core. The rotor iron core is provided with a plurality of magnetic pole windings which are equally spaced from each other. The stator iron core is at least provided with a first alternating-current (AC) supply unit and a second alternating-current (AC) supply unit. The first AC supply unit and the second AC supply unit are divided and separated from each other. The stator iron core is provided with a plurality of stator grooved teeth corresponding to the first AC supply unit and the second AC supply unit. The stator grooved teeth of the stator iron core are equally spaced from each other. The first AC supply unit includes a plurality of first coil windings. The first coil windings are wound around the stator grooved teeth of the stator iron core. The first coil windings have a first terminal connected with a first anode electric wire and a second terminal connected with a first cathode electric wire. The second AC supply unit includes a plurality of second coil windings. The second coil windings are wound around the stator grooved teeth of the stator iron core. The second coil windings have a first terminal connected with a second anode electric wire and a second terminal connected with a second cathode electric wire. The first coil windings of the first AC supply unit have a winding direction opposite to that of the second coil windings of the second AC supply unit so that the first coil windings of the first AC supply unit and the second coil windings of the second AC supply unit do not interfere with each other.

According to the primary advantage of the present invention, the power generator 10 provides and outputs at least two electric sources simultaneously so that when the power generator is operating, the power generator directly charges a battery and provides an electric power to an external load simultaneously.

According to another advantage of the present invention, the power generator 10 does not need an AC to DC converter and a DC to AC converter to prevent from causing a loss due to transformation.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a cross-sectional view showing usage of a conventional power generator in accordance with the prior art.

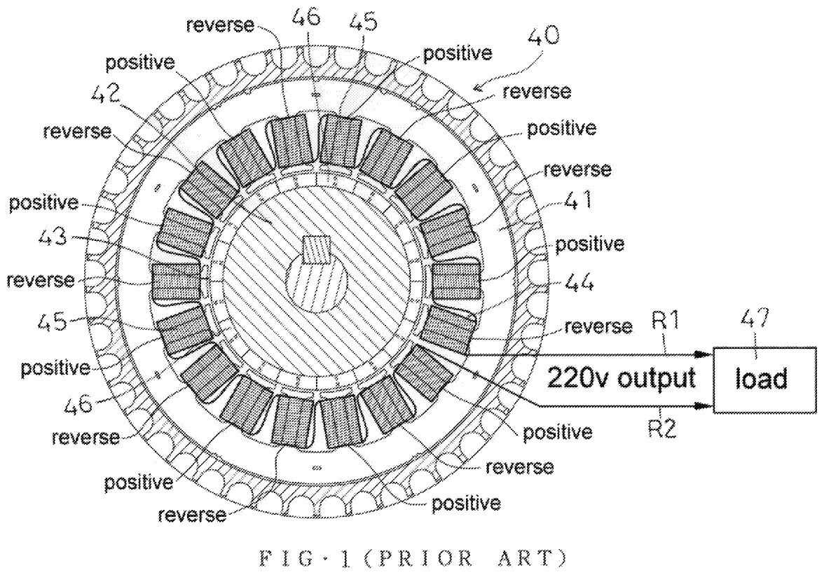

FIG. 2 is a cross-sectional view of a power generator in accordance with the preferred embodiment of the present invention.

FIG. 3 is a cross-sectional view of the power generator taken along line B-B as shown in FIG. 2.

FIG. 4 is a cross-sectional view of the power generator in accordance with another preferred embodiment of the present invention.

### DETAILED DESCRIPTION OF THE INVENTION

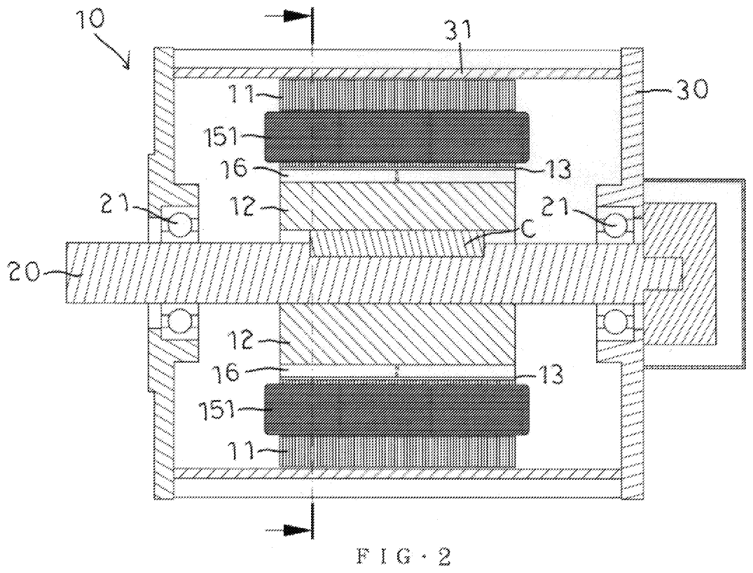

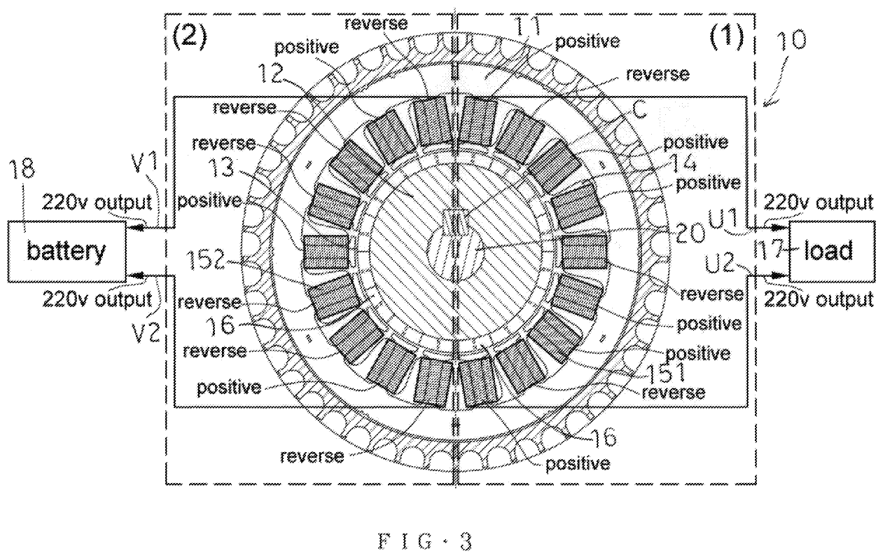

Referring to the drawings and initially to FIGS. 2 and 3, a power generator 10 in accordance with the preferred embodiment of the present invention comprises a stator iron core 11 and a rotor iron core 12 rotatably mounted in the stator iron core 11. An air gap 13 is defined between the stator iron core 11 and the rotor iron core 12 to allow rotation of the rotor iron core 12 in the stator iron core 11.

The rotor iron core 12 is provided with a plurality of magnetic pole windings 16 which are equally spaced from each other.

The stator iron core 11 is at least provided with a first alternating-current (AC) supply unit (1) and a second alternating-current (AC) supply unit (2) abutting the first AC supply unit (1). The first AC supply unit (1) and the second AC supply unit (2) are divided and separated from each other. The stator iron core 11 is provided with a plurality of stator grooved teeth 14 corresponding to the first AC supply unit (1) and the second AC supply unit (2). The stator grooved teeth 14 of the stator iron core 11 are equally spaced from each other.

The first AC supply unit (1) includes a plurality of first coil windings 151. The first coil windings 151 are wound around the stator grooved teeth 14 of the stator iron core 11. The first coil windings 151 have a first terminal connected with a first anode (or positive) electric wire U1 and a second terminal connected with a first cathode (or negative) electric wire U2.

The second AC supply unit (2) includes a plurality of second coil windings 152 adjoining the first coil windings 151 of the first AC supply unit (1). The second coil windings 152 are wound around the stator grooved teeth 14 of the stator iron core 11. The second coil windings 152 have a first terminal connected with a second anode (or positive) electric wire V1 and a second terminal connected with a second cathode (or negative) electric wire V2.

The first coil windings 151 of the first AC supply unit (1) have a winding direction opposite to that of the second coil windings 152 of the second AC supply unit (2) so that the first coil windings 151 of the first AC supply unit (1) and the second coil windings 152 of the second AC supply unit (2) do not interfere with each other. For example, the first coil windings 151 of the first AC supply unit (1) are wound in the positive direction, and the second coil windings 152 of the second AC supply unit (2) are wound in the reverse direction.

In the preferred embodiment of the present invention, the power generator 10 is a single-phase AC 220V generator.

In the preferred embodiment of the present invention, the power generator 10 further comprises a base 30, an outer cover 31 mounted on the base 30, and a rotor 20 rotatably mounted on the base 30 by two bearings 21. The stator iron core 11 is secured in the base 30 and covered by the outer cover 31. The rotor iron core 12 has a center secured on the rotor 20 by a positioning pin C.

In the preferred embodiment of the present invention, the first anode electric wire U1 and the first cathode electric wire U2 are drawn by connecting terminals and are connected to a circuit to produce an electric current. In addition, the second anode electric wire V1 and the second cathode electric wire V2 are drawn by connecting terminals and are connected to a circuit to produce an electric current.

As shown in FIG. 3, the first anode electric wire U1 and the first cathode electric wire U2 of the first AC supply unit (1) are connected to a load 17 to provide an AC voltage (such as AC220V) to the load 17. At the same time, the second anode electric wire V1 and the second cathode electric wire V2 of the second AC supply unit (2) are connected to a charger which is connected to a battery 18 so as to charge the battery 18. The charger is an AC charger, and the battery 18 is a direct-current (DC) battery (such as DC48V). Thus, the AC voltage (such as AC220V) provided by the second anode electric wire V1 and the second cathode electric wire V2 of the second AC supply unit (2) charges the battery 18 through the charger without needing an AC to DC converter and a DC to AC converter, thereby preventing from producing a transformation (or conversion) efficiency loss.

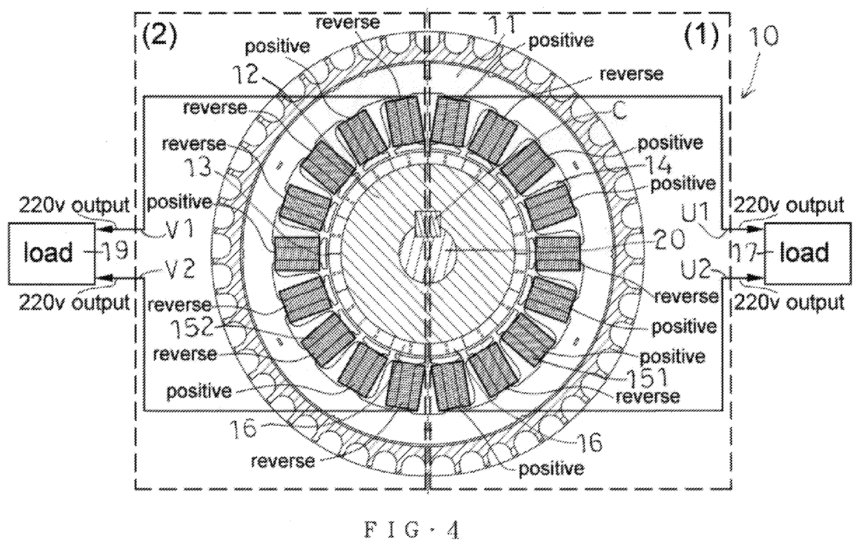

As shown in FIG. 4, the first anode electric wire U1 and the first cathode electric wire U2 of the first AC supply unit (1) are connected to a load 17 to provide an AC voltage (such as AC220V) to the load 17. At the same time, the second anode electric wire V1 and the second cathode electric wire V2 of the second AC supply unit (2) are connected to a second load 19 to provide an AC voltage (such as AC220V) to the second load 19. Thus, the power generator 10 directly provides the AC voltage to the load 17 and the second load 19 without needing an AC to DC converter and a DC to AC converter, thereby preventing from producing a transformation (or conversion) efficiency loss.

In another preferred embodiment of the present invention, the stator iron core 11 is provided with a plurality of alternating-current (AC) supply units. The AC supply units are divided and separated from each other. Each of the AC supply units includes a plurality of coil windings. Each of the coil windings are wound around the stator grooved teeth 14 of the stator iron core 11. The coil windings have a first terminal connected with an anode (or positive) electric wire and a second terminal connected with a cathode (or negative) electric wire.

Accordingly, the power generator 10 provides and outputs at least two electric sources simultaneously so that when the power generator 10 is operating, the power generator 10 directly charges a battery and provides an electric power to an external load simultaneously. In addition, the power generator 10 does not need an AC to DC converter and a DC to AC converter to prevent from causing a loss due to transformation.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A power generator comprising:
a stator iron core; and
a rotor iron core rotatably mounted in the stator iron core;
wherein:
an air gap is defined between the stator iron core and the rotor iron core to allow rotation of the rotor iron core in the stator iron core;
the rotor iron core is provided with a plurality of magnetic pole windings which are equally spaced from each other;
the stator iron core is at least provided with a first alternating-current (AC) supply unit and a second alternating-current (AC) supply unit;
the first AC supply unit and the second AC supply unit are divided and separated from each other;
the stator iron core is provided with a plurality of stator grooved teeth corresponding to the first AC supply unit and the second AC supply unit;
the stator grooved teeth of the stator iron core are equally spaced from each other;
the first AC supply unit includes a plurality of first coil windings;
the first coil windings are wound around the stator grooved teeth of the stator iron core;
the first coil windings have a first terminal connected with a first anode electric wire and a second terminal connected with a first cathode electric wire;
the second AC supply unit includes a plurality of second coil windings;
the second coil windings are wound around the stator grooved teeth of the stator iron core;
the second coil windings have a first terminal connected with a second anode electric wire and a second terminal connected with a second cathode electric wire; and
the first coil windings of the first AC supply unit have a winding direction opposite to that of the second coil windings of the second AC supply unit so that the first coil windings of the first AC supply unit and the second coil windings of the second AC supply unit do not interfere with each other.

2. The power generator as claimed in claim 1, wherein:
the stator iron core is provided with a plurality of alternating-current (AC) supply units;
the AC supply units are divided and separated from each other;
each of the AC supply units includes a plurality of coil windings;
each of the coil windings are wound around the stator grooved teeth of the stator iron core; and
the coil windings have a first terminal connected with an anode electric wire and a second terminal connected with a cathode electric wire.
